(19) United States
(12) Patent Application Publication
(10) Pub. No.: US 2008/0073337 A1
(43) Pub. Date: Mar. 27, 2008

(54) INDUCTION HEATING DEVICE FOR AN INDUCTION HOB AND INDUCTION HOB

(75) Inventor: Thomas Haag, Oberhausen-Rheinhausen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. ELEKTRO-GERAETEBAU GMBH, Oberderdingen (DE)

(21) Appl. No.: 11/858,321

(22) Filed: Sep. 20, 2007

(30) Foreign Application Priority Data
Sep. 26, 2006 (DE) 102006047121.0

(51) Int. Cl. H05B 6/12

(52) U.S. Cl. 219/622

(57) ABSTRACT

In one embodiment, an induction heating device for an induction hob has one or two coatings of insulating layers being applied to an induction coil and, above the same, a flat thermal insulation is provided. The insulating layer(s) carry on their respective upper side an electrically conductive coating connected to an earth or grounding connection so as to shunt off leakage currents, so that a user does not receive an electric shock on contacting a cooking vessel on the induction hob.

### CROSS REFERENCE TO RELATED APPLIATIONS

This application is based on German Application No. 102006047121.0 filed on Sep. 26, 2006, of which the contents are hereby incorporated by reference.

### FIELD OF INVENTION

The invention relates to an induction heating device for an induction hob, as well as an induction hob with such an induction heating device.

### BACKGROUND OF INVENTION

In the case of an induction hob having a glass ceramic plate, it is known from DE 10 2004 053 963 A1 to provide at least one of the sides of the glass ceramic plate with an earthed or grounded conductive coating. The coating serves as an electrical protection so as to ensure that if the hob plate breaks, any liquid which has overflown during a cooking process does not pass through and give rise to a short-circuit in the induction heating device below it. In addition, through such a surface positioned between the induction heating device and the cooking vessel, a voltage as a result of ever higher induction voltages and frequencies at the metallic vessel can be reduced or shunted off as a leakage current, so that a user does not receive an electric shock on contacting the vessel.

A problem solved by the invention is to provide an aforementioned induction heating device and an aforementioned induction hob obviating the prior art difficulties and which, in particular, avoids the occurrence of an aforementioned voltage at the cooking vessel, together with the risk of an electric shock.

### BRIEF DESCRIPTION OF THE DRAWINGS

Embodiments of the invention are described in greater detail hereinafter relative to the attached diagrammatic drawings, wherein:

FIG. 1 illustrates one embodiment of a side view of an inventive induction hob with an induction heating device having two electrically conductive, grounded coatings; and

FIG. 2 illustrates another embodiment of a variant of an induction heating device similar to FIG. 1.

### DETAILED DESCRIPTION OF EMBODIMENTS

This problem is solved in one embodiment by an induction heating device having the features of claim 1 and an induction hob having the features of claim 21. Advantageous and preferred embodiments of the invention are found in the further claims and are explained in greater detail hereinafter. Within the scope of the invention, the terms “coat” and “coating” mean the same. A difference only arises in the production, but not in the function for the leakage currents. The wording of the claims is by express reference made into part of the content of the description.

The induction heating device is provided for, and fixed to, an induction hob, namely under a support plate or cover of the induction hob, which is in practice often made from glass ceramic material. An induction coil of the induction heating device is positioned below it. Above the induction coil there is at least one electrically conductive, thin coating, which is placed or fixed on the induction heating device. This electrically conductive coating is grounded or earthed. This grounding or earth connection can either be direct or can be implemented in high impedance manner, for example with a resistance of 1 to 10 kOhm, and in certain cases even higher. The placing or fixing of the electrically conductive coating on the induction heating device must be such that there is a finished module, which has the induction heating device and the electrically conductive coating. During the assembly of the induction hob, said module is fitted under its support plate or cover. An important advantage compared with a coating directly on the support plate or cover is that there is no need to lead an electrical connection away from the support plate. The induction heating device already has electrical connections and conventionally also a ground or grounding connection. The electrical connection between the conductive coating and, for example, said grounding connection consequently causes no problem and can be provided within the aforementioned module. However, in the case of the aforementioned DE 10 2004 053 963 A1, not only does the induction hob support plate or cover have to be expensively coated, which for example with the normally studded glass ceramic on the underside constitutes an important cost factor. In addition, in complicated and costly manner an electrical contacting, such as for a cable or the like, must be led from said coating to a grounding connection typically located on the induction heating coil below it. This represents a major problem in the manufacture of the support plate and in particular during fitting.

According to one embodiment of the invention, a flat material is fixed or placed above the induction coil that is electrically conductively coated. Said flat material can be present as a single layer and can constitute an insulator. Preferably it constitutes an electrical insulation, such as for example an insulating layer of Kapton® or other suitable polyimide film or layer developed which can remain stable in a wide range of temperatures, or the like. Frequently, in the case of such induction heating devices, one or two layers of such an insulating layer are used. Thus, in one embodiment of the invention, one of these insulating layers or insulations, which are provided in certain cases, are coated with said coating. These insulating layers are advantageously stuck firmly onto the induction coil. Said sticking or adhesion is obviously possible to facilitate easy assembly in the same way as done with a coated insulating layer. Following adhesion, preferably the electrical connection between a grounding connection of the induction heating device and the coat or coating on the insulating layer is brought about. However, as in this state, the coating is readily accessible and no large, bulky support plate is involved; consequently, this is a relatively simple procedure to perform.

Another possibility is to provide the electrically conductive coating on a thermal insulation and advantageously the latter is a thin insulating material layer, for example, melange or fibrous material. Here again it is possible in many cases to provide such an insulating material with a metal coating, for example by vapour deposition, followed by the provision of electrical connection possibilities.

Advantageously the coat or coating is relatively thin. With a cooking vessel, it should form a capacitive voltage divider, but need not be very voluminous or thick also to ensure that no eddy currents are induced there, which are to be induced in the vessel bottom for heating purposes. The coating thickness should advantageously be below 100 μm. In one preferred embodiment, it is a maximum of 80 μm or even less than 50 μm, for example 10 μm. However, such a thin coating is still adequate for the aforementioned leakage currents, but scarcely removes energy from the magnetic field.

It is also advantageous for the aforementioned critical point, namely that preferably no eddy currents are induced in the coat or coating, if the electrical resistance of the coating is relatively high or slightly or even significantly higher than that of copper. Graphite, or metal such as aluminium, are particularly suitable as materials. Aluminium has the major advantage that it can be readily applied with controllable coating processes to non-metallic surfaces, as well as also to the aforementioned insulating layers.

In order to fulfil the aforementioned function of a capacitive voltage divider, it is advantageous if the coat or coating at least assumes the same extension or surface as the induction coil. Preferably, it projects over the induction coil somewhat laterally, for example by 5 to 10% of the diameter.

The surface of the coat or coating need not necessarily seal or completely cover the induction coil. It can advantageously be in the form of a fork, a star, etc. and connected at one point to the ground or earth potential. In one embodiment, the coating can have the shape of a spiral, for example an Archimedean spiral, in which the connection to the ground potential takes place at a point of the spiral.

For the aforementioned function as a charge eliminator, it can be advantageous that there are two or even more electrically conductive coatings. They must naturally have a limited mutual spacing. This can for example be brought about in that one coating is provided on an aforementioned insulating layer and another coating on an aforementioned thermal insulation. Alternatively, two such coated insulating layers can be provided. It is particularly advantageous within the scope of the invention that the coat or coating is separate from the cover or support plate. It is also advantageous if it also has a certain spacing therefrom, i.e., it is not also applied to or contacts the underside of the cover.

These and further features can be gathered from the claims, description and drawings and the individual features, both singly or in the form of sub-combinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

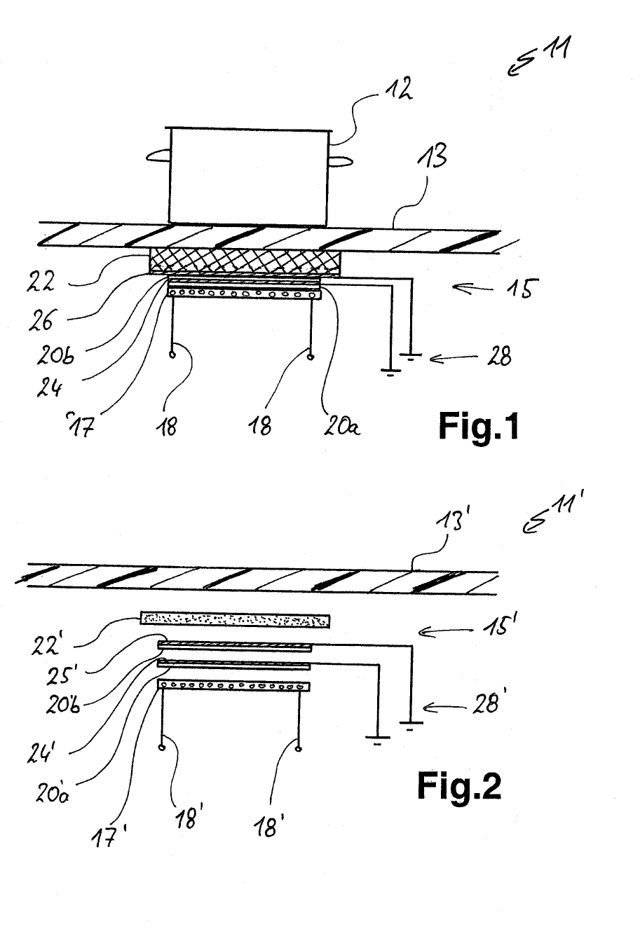

FIG. 1 shows an induction hob 11 with a hob plate 13 according to the invention in a highly diagrammatic, lateral section. The induction hob 11 with the cooking vessel 12 thereon is provided with an induction heating device 15 beneath hob plate 13. Induction heating device 15 has an induction coil 17, which can have a conventional construction. Above the induction coil 17 there is an insulating layer 20a and above this a further insulating layer 20b. Such insulating layers are also used in connection with induction coils in the prior art and can for example be made from a polyimide film, or a so-called mica sheet. A thermal insulation layer 22 is provided above insulating layers 20a, 20b and in particular serves in the case of an excessive heating of the bottom of the cooking vessel 12 and heat transmission through the hob plate 13, to prevent overheating and damage to the induction heating device 15. The thermal insulation 22 can comprise so-called melange, which is a mixture of thermally insulating fibres. The insulation layer can either be relatively inherently stable or very soft in the manner of a fabric. The thermal insulation 22 can also be a thick mica layer and have stable mechanical characteristics.

Thus, the thermal insulation 22 forms a thermal separation or thermal protection for the induction heating device 15. The insulating layers 20a, 20b form an electrical insulation or a protection for the user above hob plate 13, particularly with the aim of bringing the induction heating device into a different protection class. For this the electrically conductive coatings 24 and 26 are provided. The first electrically conductive coating 24 is applied to the upper side of the lower insulating layer 20a. The second electrically conductive coating 26 is applied to the underside of thermal insulation 22. The two coatings 24 and 26 are grounded with grounding connections 28 or connected to ground. Coatings 24 and 26 can have a different construction or production, depending on the substrate to which they are applied and this will be explained in greater detail hereinafter.

In this representation, all the coatings rest on one another as in the installation state and the complete module of the induction heating device 15 is pressed onto the underside of the hob plate 13. However, the representation is not to scale and is instead purely diagrammatic. Thus, in particular the coatings 24 and 26 are shown much thicker than in actual practice. As described hereinbefore, the coating can be made of aluminium, because such coatings can be readily applied to the aforementioned insulating layers.

FIG. 2 shows a variant of an induction heating device 15′ and here the structure of said device is shown in an exploded diagrammatic manner with the individual parts shown separately for ease of examination. Above the induction coil 17′ there are once again two insulating layers 20′a and 20′b over which once again runs a thermal insulation 22′, which is here made from mica. These parts correspond to those in FIG. 1. The difference is that the thermal insulation 22′ does not carry an electrical conductive coating, but instead only the insulating layers 20a′ and 20′b carry the coating. Insulating layer 20′a carries a first coating 24′ and insulating layer 20′b a second coating 25′. Thermal insulation 22′ has no electrically conductive coating. This is advantageous in that a coating of the material of the thermal insulation 22′ with conductive material may in some cases be difficult. Moreover, the insulating layer can be provided in mass production form with a corresponding, electrically conductive coating and then only a single type of insulating layer has to be processed.

In connection with the constructions of FIGS. 1 and 2, it is pointed out that an electrical contacting must be performed on the electrically conductive coating provided and relative to the grounding connections 28. This is not shown in detail in the figures, but can easily be implemented by one skilled in the art. For example, a connection can take place through the flat adhesion of a conductive pad or the like to a cable.

In connection with the drawings it is also pointed out that here the induction heating device is an assembled module attached as a single part during installation to the induction hob 11 or below the hob plate 13. In practice, this is usually implemented in such a way that the insulating layer has a self-adhesive on one side and in this way can be adhered to the top of the induction coil 17 and then the thermal insulation 22 is fixed thereto. For example, it can also be stuck on or otherwise attached. Alternatively, it possible to use a two-sided adhesive tape or the like. A further alternative involves providing an adhesion coating on both sides of the upper insulating layer 20. Thus, in practice the coatings on induction coil 17 form a flat union, which is firmly attached to the induction coil.

Advantageously the thermal insulation 22 engages on the underside of hob plate 13. In one embodiment of the invention there is no electrically conductive coating on the hob plate 13, which in the case of a coating on thermal insulation 22 is provided in the manner shown in FIG. 1 on the underside. Within the scope of the invention, it is also possible to only provide one insulating layer 20. For simplification reasons during production, it is also possible for only this insulating layer to have on its top surface an electrically conductive coating connected to a grounding connection.

Even if the coatings 24, 25′ and 26 are thin, for example in a range below the aforementioned 100 μm, the resulting effect is still possible, namely that leakage currents can be shunted off via them to a grounding connection 28 and therefore to ground and not to the user. Thus, if electric power, or voltage and frequency, at the induction coil is raised above the normal level, it is possible to ensure that higher eddy currents are not induced in the cooking utensil 12. It is possible to avoid a voltage drop with potential difference in the utensil due to the eddy current flow, which in the case of contact on the part of the user with said utensil 12 could give rise to a small electric shock. The discharge of the leakage currents reduces the electric voltage at the cooking utensil and in this way eliminates the electric shock rise.

1. An induction heating device for an induction hob comprising a support plate serving as a hob plate, said induction heating device comprising a flat induction coil for placement below said support plate, wherein above said induction coil there is provided at least one thin electrically conductive coating attached to said induction heating device, wherein said thin electrically conductive coating is connected to a grounding connection.

2. The induction heating device according to claim 1, wherein said thin electrically conductive coating comprises a flat material positioned above said induction coil.

3. The induction heating device according to claim 2, wherein said flat material comprises an electrical insulation.

4. The induction heating device according to claim 2, wherein said flat material comprises a thermal insulation.

5. The induction heating device according to claim 3, wherein said electrical insulation above said induction coil is adhered to said thin electrically conductive coating.

6. The induction heating device according to claim 5, wherein said electrical insulation is adhered to said induction coil.

7. The induction heating device according to claim 6, wherein said thermal insulation is adhered to said thin electrically conductive coating.

8. The induction heating device according to claim 1, wherein said thin electrically conductive coating no more than 100 μm thick.

9. The induction heating device according to claim 1, wherein said thin electrically conductive coating is less than 80 μm thick.

10. The induction heating device according to claim 1, wherein said thin electrically conductive coating is made from a material with an electrical resistance higher than that of copper.

11. The induction heating device according to claim 1, wherein said thin electrically conductive coating comprises graphite or aluminium.

12. The induction heating device according to claim 1, wherein said thin electrically conductive coating is connected in a high impedance manner with said grounding connection.

13. The induction heating device according to claim 1, wherein said thin electrically conductive coating has a surface area which is at least as large as a surface area of said heating coil.

14. The induction heating device according to claim 1, wherein said thin electrically conductive coating laterally projects over said induction coil.

15. The induction heating device according to claim 14, wherein said thin electrically conductive coating laterally projects over said induction coil by at least 10% of a diameter of said induction coil.

16. The induction heating device according to claim 1, wherein said thin electrically conductive coating has a shape of a spiral, a fork, or a star.

17. The induction heating device according to claim 1, wherein there is a thermal insulation above said induction coil and said thermal insulation is attached to said electrically conductive, thin coating.

18. The induction heating device according to claim 17, wherein said thermal insulation is adhered to said thin electrically conductive coating on an underside.

19. The induction heating device according to claim 1, wherein two thin electrically conductive coatings are provided in a spaced apart parallel manner.

20. The induction heating device according to claim 19, wherein said two thin electrically conductive coatings have at least one component between them.

21. An induction hob comprising a:
support plate forming a hob plate; and
an induction heating device positioned below said support plate wherein the induction heating device comprises an induction coil and a thin electrically conductive coating attached to said induction coil wherein said conductive coating is connected to an electrical ground.

22. The induction hob according to claim 21, wherein said thin electrically conductive coating is positioned parallel to said support plate and positioned between said induction coil and said support plate, wherein further said thin electrically conductive coating is not in contact with said support plate.

23. The induction hob according to claim 22, wherein said support plate is a glass ceramic plate.

24. The induction hob according to claim 21, wherein said induction heating device is positioned onto an underside of said support plate and electrical insulation is positioned between said induction heating device and said support plate.

25. The induction hob according to claim 21, wherein said induction heating device is positioned onto an underside of said support plate and thermal insulation is positioned between said induction heating device and said support plate.
